(19) United States
(12) Patent Application Publication
(10) Pub. No.: US 2018/0031456 A1
(43) Pub. Date: Feb. 1, 2018

(54) LIFT TABLE FOR A LOAD FRAME

(71) Applicant: GM Global Technology Operations LLC, Detroit, MI (US)

(72) Inventors: Ella Yung, Rochester Hills, MI (US); Leonard G. Posh, Canton, MI (US); Raid R. George, West Bloomfield, MI (US)

(21) Appl. No.: 15/223,923

(22) Filed: Jul. 29, 2016

(51) Int. Cl. G01N 3/04; G01N 3/06

(52) U.S. Cl. CPC G01N 3/04; G01N 3/062; G01N 2203/04; G01N 2203/0423; G01N 2203/06

(57) ABSTRACT

A lift table includes a first adjuster having a base with a bore and a collet that is threaded into the bore of the base, the first adjuster being configured to selectively secure the lift table to the load frame, and a plate that sits atop the collet, the plate being configured to hold a fixture that is attached to the load frame. Rotation of the collet in a first direction relative to the base raises the plate and rotation of the collet in a second direction relative to the base lowers the plate.

### FIELD

The present disclosure relates to a lift table. More specifically, the present disclosure relates to a lift table for a load frame.

### BACKGROUND

The statements in this section merely provide background information related to the present disclosure and may not constitute prior art.

In various industries, load frames are employed to evaluate the tensile/compressive properties of certain components. These load frames require the use of heavy fixtures and load cells that are difficult to install and remove. For example, heavy tensile test fixtures are difficult to attach to the load frame crosshead because the operator typically uses one hand for holding the fixture and maintaining alignment and the other hand for turning the fixture to thread its threaded end into the crosshead. Moreover, removing heavy fixtures from the load frame produce additional issues. For example, as the fixture is being removed from the crosshead, the operator may not be able to identify when the threads are about to run out. Consequently, the fixture may fall which requires the operator to quickly catch the fixture and might pose safety hazards/injuries.

Accordingly, there is a need in the art for an apparatus that enables easy and safe installation and removal of heavy fixtures and load cells from a load frame.

### SUMMARY

The present invention provides a lift table for a load frame.

Accordingly pursuant to one aspect, a lift table includes a first adjuster having a base with a bore and a collet that is threaded into the bore of the base, the first adjuster being configured to selectively secure the lift table to the load frame, and a plate that sits atop the collet, the plate being configured to hold a fixture that is attached to the load frame. Rotation of the collet in a first direction relative to the base raises the plate and rotation of the collet in a second direction relative to the base lowers the plate.

This aspect may be further characterized by one or any combination of the features described herein, such as :the first adjuster includes a locking feature to prevent over-rotation and separation of the collet from the base; the lift table includes a second adjuster, the first adjuster being a coarse adjuster and the second adjuster being a fine adjuster; the second adjuster enables rotation of the plate relative to the collet in the first direction to raise the plate and rotation of the plate relative to the collet in the second direction to lower the plate; the second adjuster includes a locking feature to prevent over-rotation and separation of the plate from the collet; the table includes centering marks to aid in aligning the fixture; the lift table further includes a centering tool secured to the top of the plate to aid in aligning the fixture on top of the plate; the fixture is provided with a thread end indicator to warn of thread disengagement of the fixture from the load frame; the collet includes one or more notches that engage with a wrench to provide leverage for rotating the collet; the lift table may further includes a spring-load mechanism that prevents binding during rotation and secures the plate to the collet.

Accordingly, pursuant to another aspect, a lift table for a load frame includes a coarse adjuster having a base with a bore and a collet that is threaded into the bore of the base, the coarse adjuster being configured to selectively secure the lift table to the load frame, a plate that sits atop the collet, the plate being configured to hold a fixture that is attached to the load frame, rotation of the collet in a first direction relative to the base raising the plate and rotation of the collet in a second direction relative to the base lowering the plate, and a fine adjuster that enables rotation of the plate relative to the collet in the first direction to raise the plate and rotation of the plate relative to the collet in the second direction to lower the plate.

This aspect may be further characterized by one or any combination of the features described herein, such as: the coarse adjuster includes a locking feature to prevent over-rotation and separation of the collet from the base; the fine adjuster includes a second locking feature to prevent over-rotation and separation of the plate from the collet; the lift table further includes a centering tool secured to the top of the plate to aid in aligning the fixture on top of the plate.

Accordingly, pursuant to another aspect, a lift table for a load frame includes an adjuster having a base with a bore and a collet that is threaded into the bore of the base, the adjuster being configured to selectively secure the lift table to the load frame; a plate that sits atop the collet, the plate being configured to hold a fixture that is attached to the load frame, rotation of the collet in a first direction relative to the base raising the plate and rotation of the collet in a second direction relative to the base lowering the plate, and a spring-load mechanism that prevents thread binding during rotation, and secures the plate to the collet, the spring-load mechanism including a plurality of springs positioned to float the plate on top of the collet. The plurality of springs may be rated for about 50 Newtons in excess to the total weight of the fixture.

Further features, advantages, and areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way. The components in the figures are not necessarily to scale, emphasis instead being placed upon illustrating the principles of the invention. In the drawings:

FIG. 1 illustrates a spring-less lift table for a load frame in accordance with the principles of the present invention;

FIG. 2 illustrates various fixtures for use in the load frame;

FIG. 3 illustrates the lift table with a fixture;

FIG. 4 is a cross-sectional view of the spring-less lift table;

FIG. 5 is a close-up view of thread-end indicator in accordance with the principles of the present invention;

FIGS. 6A and 6B illustrate the thread-end indicator in use;

FIG. 7 illustrates various centering tools for use with the lift table;

FIG. 8 illustrates a centering tool in use with a fixture;

FIG. 9 illustrates the spring-loaded lift table in accordance with the principles of the present invention; and

FIG. 9A is a close-up view of the region 9A in FIG. 9.

### DETAILED DESCRIPTION

The following description is merely exemplary in nature and is not intended to limit the present disclosure, application, or uses.

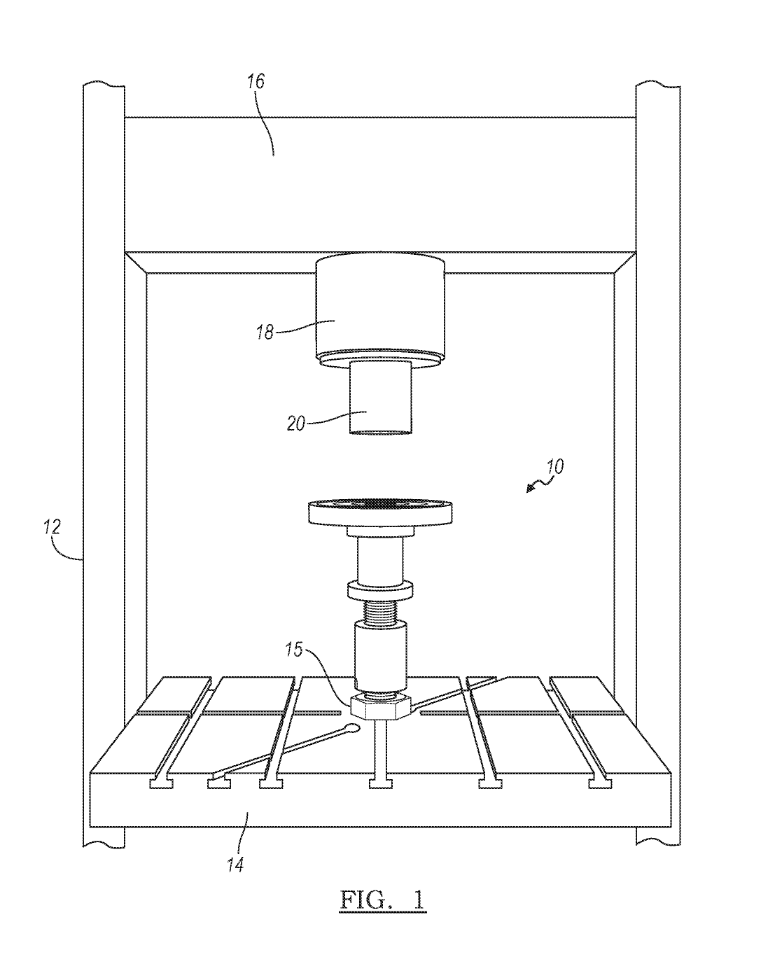

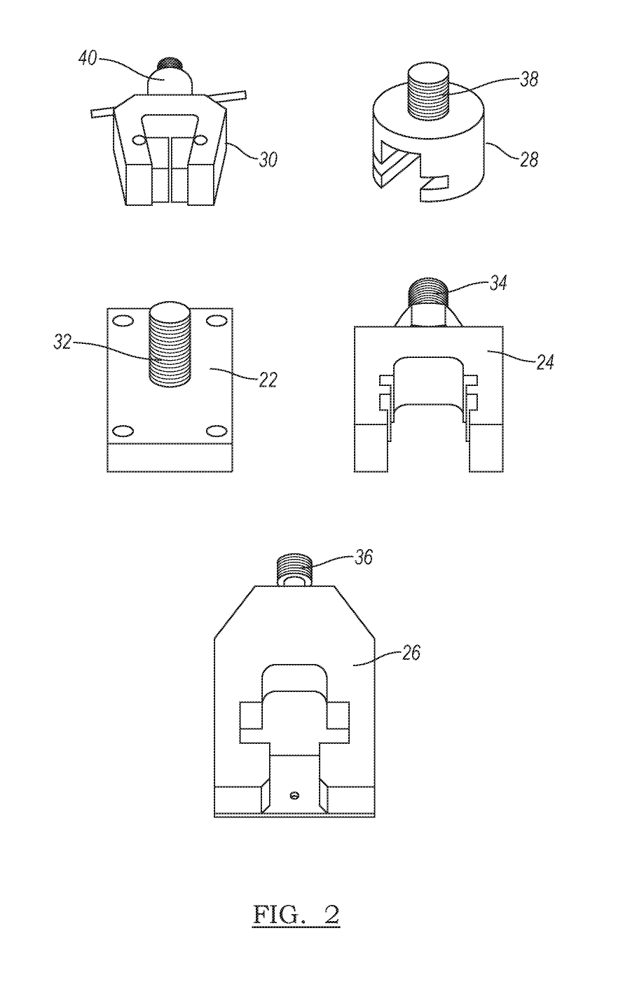

Referring now to FIG. 1, a lift table embodying the principles of the present invention is illustrated therein and designated at 10. The lift table 10 is selectively secured to a T-slotted table 14 of a load frame 12 with a nut 15. The lift table 10 is employed for attaching various types of fixtures 22, 24, 26, 28, and 30 shown in FIG. 2, as well as accessory load cells, to the main load cell 18. The adaptor 20 is attached to a load cell 18 which, in turn, is attached to a crosshead 16. Specifically, any one of the fixtures 22, 24, 26, 28 and 30 are initially placed on top of the lift table 10, which is employed to raise the selected fixture 22, 24, 26, 28 or 30 up to the adaptor 20 to enable threading a threaded end 32, 34, 36, 38 or 40 into the adaptor 20. After, the fixture 22, 24, 26, 28 or 30 is attached to the adaptor, the lift table 10 is lowered and removed from the load frame's T-slotted table 14.

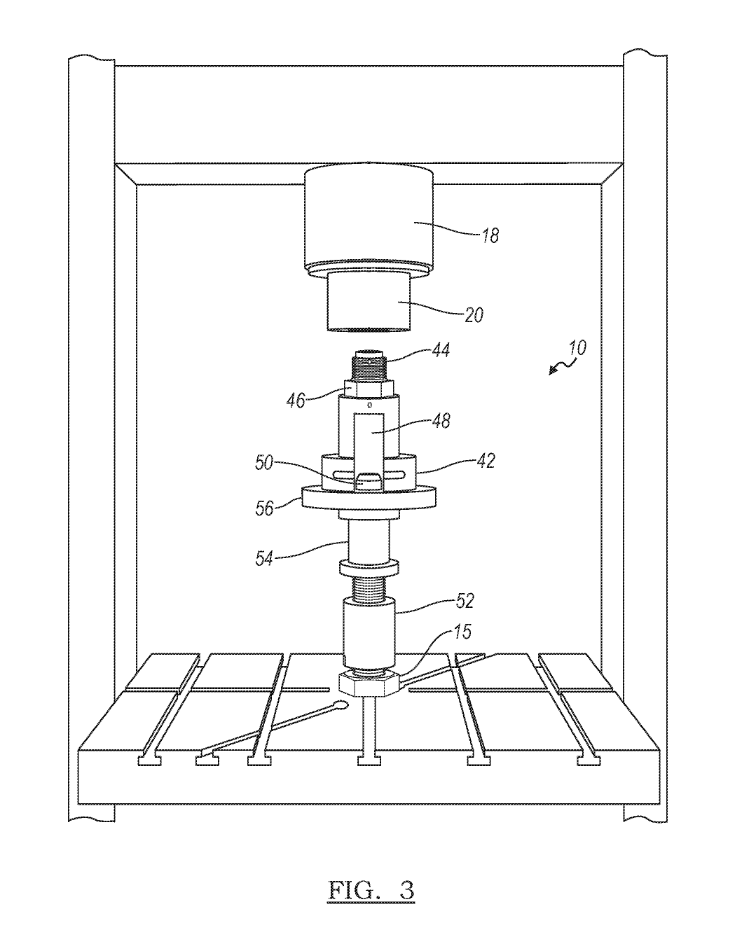

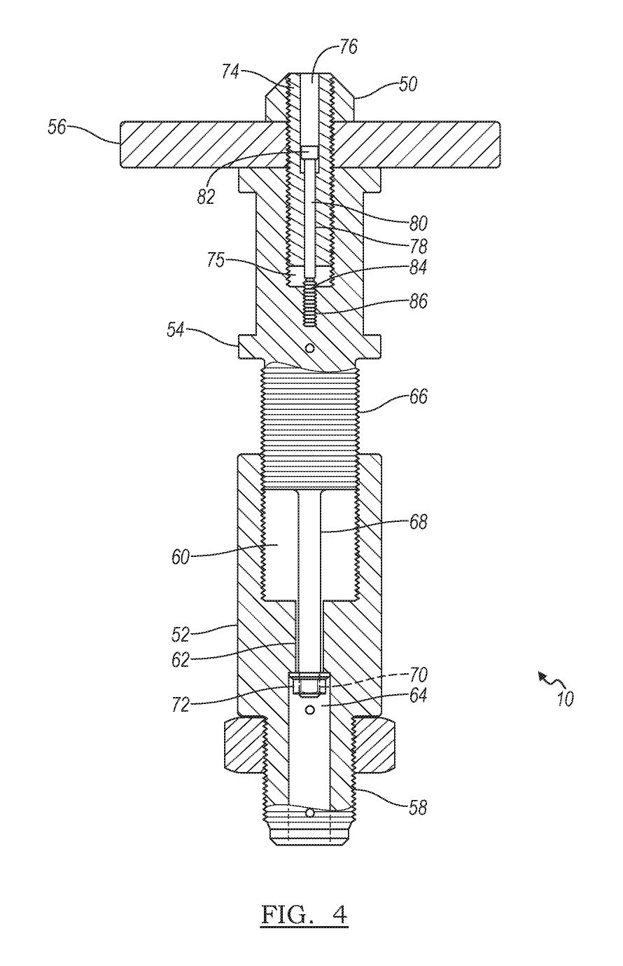

Referring now to FIG. 3, there is shown a particular fixture 42 placed on the lift table 10 prior to attaching threaded end 44 of the fixture 42 to the adaptor 20. Referring also to FIG. 4, the lift table 10 includes a base 52 with a threaded end 58 that is configured to be threaded into load frame's T-slotted table 14 and secured with a nut 15. The lift table 10 also includes a collet 54 threaded into the base 52 and a plate 56 threaded into the collet 54. More specifically, the collet 54 includes a threaded end 66 that threads into an enlarged bore region 60 of the base 52. Hence, rotating the collet 54 in one direction, for example, counter-clockwise, raises the collet 54 relative to the base 52, while rotating the collet 54 in the opposite direction, for example, clockwise, lowers the collet 54.

The plate 56 is generally circular in various arrangements and is attached to the collet 54 with a hollow threaded stud or shaft 74, and a centering tool 50 is threaded onto the shaft 74 to secure the plate 56 to the collet 54. As such, as the plate 56 is rotated in one direction, for example, counter-clockwise, the shaft 74 threads out of a bore 75 of the collet 54 to raise the plate 56 relative to the collet 54. And when the plate 56 is rotated in the opposite direction, for example, clockwise, the shaft 74 threads into the bore 75 to lower the plate 56 relative to the collet 54. In the particular arrangement shown in FIG. 4, the shaft 74 has a 1″-14 thread and the threaded end 66 has a 2″-12 thread. Accordingly, rotation of the collet 54 relative to the base 52 provides a coarse adjuster to raise and lower the plate 56 while rotation of the plate 56 relative to the collet 54 provides a fine adjuster to raise and lower the plate 56.

Each of the aforementioned adjusters includes a locking feature to prevent separation of the collet 54 from the base 52 and separation of the plate 56 from the collet 54 during the operation of the lift table 10. Specifically, the collet 54 includes a shaft 68 that extends from its threaded end 66. The shaft 68 extends through the enlarged bore 60, through a reduced bore region 62 into an end bore region 64. The shaft 68 has a threaded end 70 onto which a nut 72 is attached. The nut 72 allows the shaft 68 to reciprocate in the bore regions 60, 62 and 64. The flange of nut 72, however, is large enough to prevent the nut 72 and hence the thread end 70 from entering into the reduced bore region 62. Accordingly, as the collet 54 is rotated counter-clockwise to raise the plate 56, the nut 72 ultimately prevents the shaft 68 and consequently the collet 54 from rising further relative to the base 52. Thus, this locking feature prevents the over-rotation and separation of the collet 54 from the base 52.

As for the locking feature of the fine adjuster, a bolt 80 has a threaded end 84 that threads into a region 86 of the collet 54. The bolt 80 extends through an enlarged bore 76 and a reduced bore 78 of the threaded shaft 74. The bolt 80 includes an enlarged end 82 that is sized to prevent it from entering into the reduced bore 78. Hence, when the lift table is in use, the bolt 80 remains stationary relative to the collet 54, while the threaded shaft 74 and the plate 56 rises and lowers relative to the collet 54 and the enlarged end 82 is able to reciprocate in the enlarged bore 76. As the plate 56 is rotated to raise the plate 56, the enlarged end 82 ultimately is prevented from entering into the reduced bore 78 to prevent the threaded shaft 74 and the plate 56 from rising further relative to the collet 54, which prevent the over-rotation and separation of the plate 56 from the collet 54.

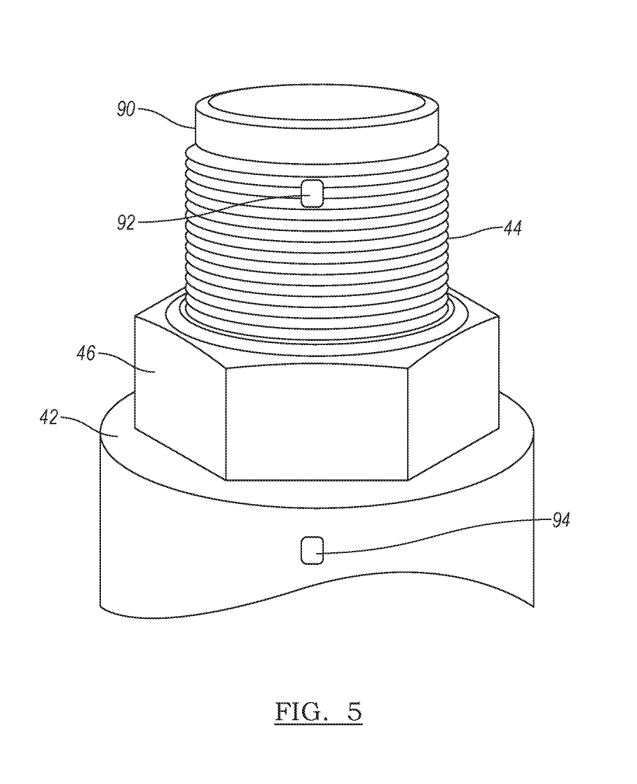

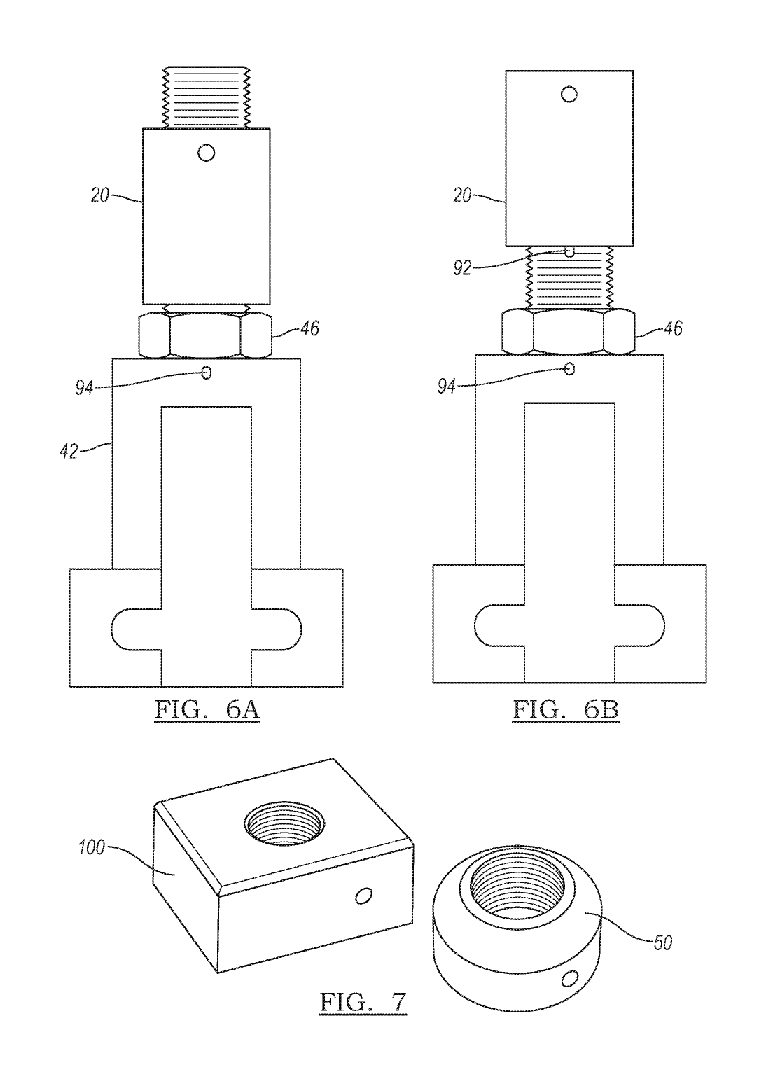

In various arrangements the threaded ends 32, 34, 36, 38, 40 and 44 of the fixtures 22, 24, 26, 28, 30 and 42 include a thread end indicator and a dog-point 90 that facilitates alignment of the threaded end 44 with respect to the adaptor 20 (FIGS. 6A and 6B). For example, as shown in FIG. 5, the threaded end 44 of the fixture 42 includes a milled slot 92 that is aligned with milled slot 94 on a surface of fixture 42. The milled slot 92 can be positioned on, for example, the last two threads of the threaded end 44. Accordingly, after the threaded end 44 is threaded and engaged with the adaptor 20, an operator can rotate the fixture 42 to disengage the fixture 42 from the adaptor 20. As the operator continues to rotate the fixture 42, the milled slot 94 (FIG. 6A) alerts the operator where to look for the milled slot 92. When the milled slot 92 ultimately appears (FIG. 6B), the operator knows that the thread disengagement is imminent.

Referring now to FIG. 7, there is shown a centering tool 100 along with the centering tool 50. The centering tool 50 is shaped and sized, for example, cone frustum shape, to fit within a region 48 (FIG. 3) of the fixture 42 to facilitate centering the fixture 42 relative to the plate 56. Note that the surface of the plate 56 may include inscribed concentric rings 57 to also aid in centering a fixture onto the plate 56. Hence, after the fixture 42 is centered onto the plate 56, the operator rotates the coarse and fine adjuster to raise the threaded end 44 to the adaptor 20. The dog point 90 helps guide the threaded end 44 into the adaptor 20 so that further rotation of the fixture 42 secures the fixture to the adaptor 20. The reverse process is employed to remove the fixture 42 from the adaptor 20.

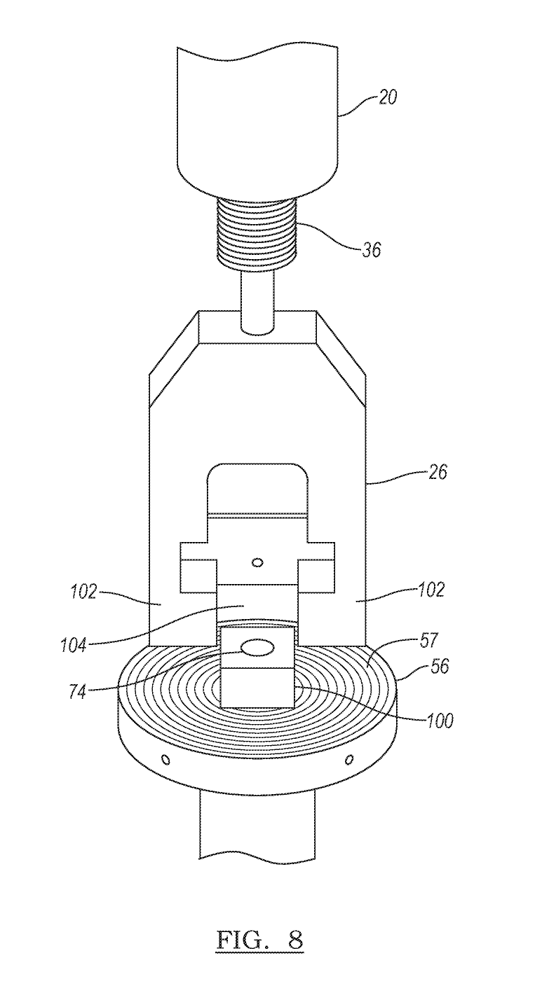

The centering tool 100 has a rectangular cross-section and is configured to center a fixture with an opening that corresponds to the shape of the tool 100. For example, as shown in FIG. 8, the fixture 26 includes a pair of arms 102 that are spaced apart to define a region 104. The tool 100 is threaded onto the shaft 74 to secure the tool 100 to the plate 56. The tool 100 is sized and shaped to fit within the region 104 of the fixture 26. Hence, an operator is able to place and center the fixture 26 on the plate 56 with the aid of the centering tool 100 to facilitate threading the threaded end 36 into the adaptor 20. Other sized and shaped centering tools are contemplated depending on the interior region of the fixture being attached to the adaptor 20.

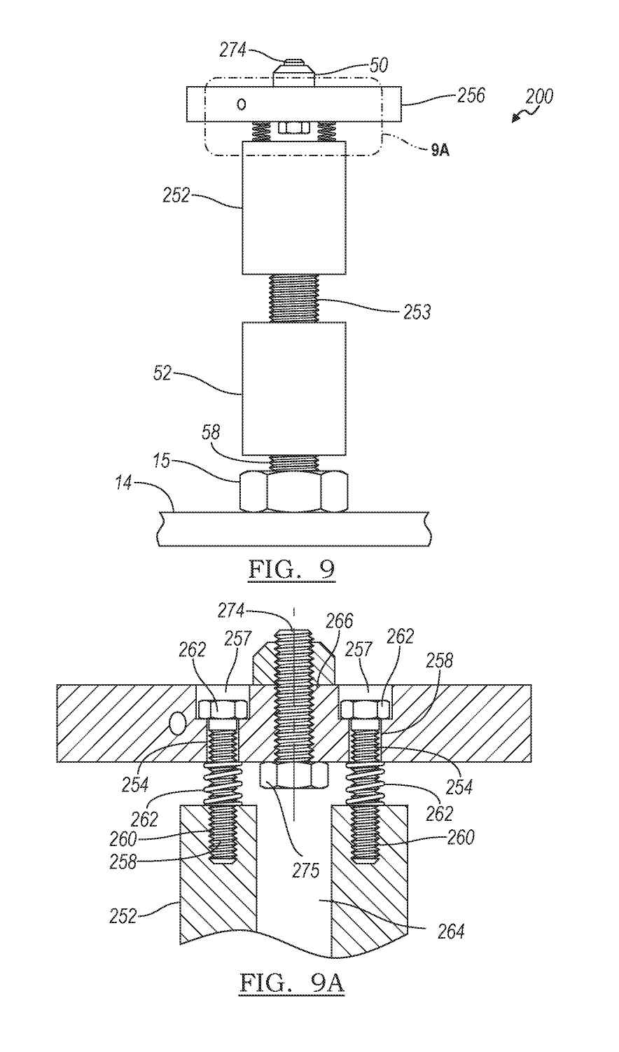

Referring now to FIG. 9, there is shown an alternative lift table 200 with a spring load mechanism in accordance with the principles of the present invention. The lift table 200 includes a collet 252 with a threaded end 253 that threads into the base 52. The centering tool 50 or the centering tool 100 is attached to plate 256 via a threaded bolt 274. The enlarged end 275 of the bolt 274 is sized to be slightly smaller than a bore 264 of the collet 252 so that the enlarged end 275 can fit within the bore 264. The plate 256 includes a set of counter-bore regions 257 and 258. A set of respective allen head shoulder bolts 254 include shaft portions 258 that thread into threaded regions 260 in the collet 252. The allen head shoulder bolts 254 include enlarged ends 262 that fit within the bore regions 257 but are larger than the bore regions 258. A set of springs 262 are placed about the shoulder regions of allen head shoulder bolts 254 and between the plate 256 and the collet 252. Hence, in this arrangement, the springs 262 provide an upward biasing force so that the plate 256 floats on top of the collet 252, while the allen head shoulder bolts 254 prevent the separation of the plate 256 from the collet 252. The number of springs 262 and corresponding allen head shoulder bolts 254 can be as few as six to eight. In various arrangements, the combined set of springs is rated for about 50 Newtons in excess to the total fixture weight. As such, when a fixture is placed on the table 256, rotation of the plate 256 along with the collet 252, for example, counter-clockwise, relative to the base 52 raises the plate and the fixture up to the adaptor 20. Since the plate 256 floats on the springs 262, the plate 256 is able to tilt off axis from a longitudinal axis extending along the threaded bolt 274. Such movement helps in aligning the threaded end of any of the aforementioned fixtures with the adaptor 20 so that the threaded end can be threaded into the adaptor 20. The process is reversed to remove the fixture from the adaptor 20. Accordingly, the spring-loaded lift table 200 can be used with all load frames. The springs will support the fixture weight and give approximately 50 Newtons of usable end force for assembling the fixture to the load frame 12.

Although the above arrangements employs four springs and generates approximately 205 Newtons of lifting force, other arrangements employ six to eight springs and generate the same force. By placing the springs under the plate on, for example, a five inch bolt circle, the fixture weight is evenly supported around the table, which eliminates any uneven tipping forces on the table. After supporting all the fixtures' weight, a small spring force of approximately 50 Newtons remains for fixture assembly. This small end load is enough to allow the threads to smoothly engage and allow the fixtures to be threaded together without binding during the installation process.

In another configuration, a lift table without any springs can be used with load frames that have an electronic circuit such as, for example, the Specimen Protect feature available from Instron Corporation. The electronic circuit in these load frames will allow the lift table to work correctly without the springs. For example, the Specimen Protect circuit works by adjusting the crosshead 16 position up or down to maintain the required usable end load of approximately 50 Newtons. This is the same process as the spring-loaded option

In sum, the lift tables 10 and 200 hold and support the weight of heavy fixtures and load cells, while allowing for the installation and removal of the threaded ends of the fixtures and load cells from the crosshead of the load frame. This eliminates the dependence on the operator's physical strength, improves efficiency, and prevents safety/ergonomic issues associated with lifting heavy items.

The description of the invention is merely exemplary in nature and variations that do not depart from the gist of the invention are intended to be within the scope of the invention. Such variations are not to be regarded as a departure from the spirit and scope of the invention.

What is claimed is:

1. A lift table for a load frame comprising:
a first adjuster having a base with a bore and a collet that is threaded into the bore of the base, the first adjuster being configured to selectively secure the lift table to the load frame; and
a plate that sits atop the collet, the plate being configured to hold a fixture that is attached to the load frame,
wherein rotation of the collet in a first direction relative to the base raises the plate and rotation of the collet in a second direction relative to the base lowers the plate.

2. The lift table of claim 1 wherein the first adjuster includes a locking feature to prevent over-rotation and separation of the collet from the base.

3. The lift table of claim 1 further comprising a second adjuster, the first adjuster being a coarse adjuster and the second adjuster being a fine adjuster.

4. The lift table of claim 3 wherein the second adjuster enables rotation of the plate relative to the collet in the first direction to raise the plate and rotation of the plate relative to the collet in the second direction to lower the plate.

5. The lift table of claim 3 wherein the second adjuster includes a locking features to prevent over-rotation and separation of the plate from the collet.

6. The lift table of claim 1 wherein the table includes centering marks to aid in aligning the fixture.

7. The lift table of claim 1 further comprising a centering tool secured to the top of the plate to aid in aligning the fixture on top of the plate.

8. The lift table of claim 1 wherein the fixture is provided with a thread end indicator to warn of thread disengagement of the fixture from the load frame.

9. The lift table of claim 1 wherein the collet includes a one or more notches that engage with a wrench to provide leverage for rotating the collet.

10. The lift table of claim 1 further comprising a spring-load mechanism that prevents thread binding during rotation and secures the plate to the collet.

11. The lift table of claim 10 wherein the spring-load mechanism includes a plurality of springs positioned to float the plate on top of the collet.

12. The lift table of claim 11 wherein the plurality of springs is rated for about 50 N in excess of the total fixture weight.

13. A lift table for a load frame comprising:
a coarse adjuster having a base with a bore and a collet that is threaded into the bore of the base, the coarse adjuster being configured to selectively secure the lift table to the load frame;
a plate that sits atop the collet, the plate being configured to hold a fixture that is attached to the load frame, rotation of the collet in a first direction relative to the base raising the plate and rotation of the collet in a second direction relative to the base lowering the plate; and
a fine adjuster that enables rotation of the plate relative to the collet in the first direction to raise the plate and rotation of the plate relative to the collet in the second direction to lower the plate.

14. The lift table of claim 13 wherein the coarse adjuster includes a locking feature to prevent over-rotation and separation of the collet from the base.

15. The lift table of claim 14 wherein the fine adjuster includes a second locking feature to prevent over-rotation and separation of the plate from the collet.

16. The lift table of claim 15 further comprising a centering tool secured to the top of the plate to aid in aligning the fixture on top of the plate.

17. A lift table for a load frame comprising:
an adjuster having a base with a bore and a collet that is threaded into the bore of the base, the adjuster being configured to selectively secure the lift table to the load frame;
a plate that sits atop the collet, the plate being configured to hold a fixture that is attached to the load frame, rotation of the collet in a first direction relative to the base raising the plate and rotation of the collet in a second direction relative to the base lowering the plate; and
a spring-load mechanism that prevents thread binding during rotation and secures the plate to the collet, the spring-load mechanism including a plurality of springs positioned to float the plate on top of the collet.

18. The lift table of claim 17 wherein the plurality of springs is rated is rated for about 50 N in excess of total fixture weight.

19. The lift table of claim 17 further comprising a centering tool secured to the top of the plate to aid in aligning the fixture on top of the plate.

20. The lift table of claim 17 wherein the collet includes a one or more notches that engage with a wrench to provide leverage for rotating the collet.
